(19) United States
(12) Patent Application Publication
(10) Pub. No.: US 2026/0111073 A1
(43) Pub. Date: Apr. 23, 2026

(54) ELECTRONIC DEVICE AND METHOD FOR OPTIMIZING APPLICATIONS

(71) Applicant: Samsung Electronics Co., Ltd., Suwon-si (KR)

(72) Inventors: Kwanhee JEONG, Suwon-si (KR); Hyoungjong KIM, Suwon-si (KR)

(21) Appl. No.: 19/423,164

(22) Filed: Dec. 17, 2025

Related U.S. Application Data
(63) Continuation of application No. PCT/KR2024/009366, filed on Jul. 3, 2024.

(30) Foreign Application Priority Data
Jul. 5, 2023 (KR) 10-2023-0087377
Aug. 1, 2023 (KR) 10-2023-0100311

(51) Int. Cl. G06F 1/329; G06F 1/3212

(52) U.S. Cl. CPC G06F 1/329; G06F 1/3212

(57) ABSTRACT

An electronic device is provided. The electronic device includes at least one processor including processing circuitry, a battery, and memory storing instructions, wherein the instructions, when executed by the at least one processor individually or collectively, cause the electronic device to identify whether the state of the electronic device corresponds to an application optimization execution condition, identify whether the power level of the battery being charged is less than or equal to a designated power level, in case that the power level of the battery being charged is less than or equal to the designated power level, generate a list of applications that are to undergo application optimization, identify information about the temperature of the electronic device, and execute the application optimization, based on the list and the temperature, wherein the operation of executing the application optimization on the basis of the list includes an operation of adjusting the number of applications to be optimized, and wherein the executing of the application optimization, based on the temperature includes performing control to execute rescheduling in case that the current temperature of the electronic device exceeds a designated temperature.

### CROSS-REFERENCE TO RELATED APPLICATION(S)

This application is a continuation application, claiming priority under 35 U.S.C. § 365 (c), of an International application No. PCT/KR2024/009366, filed on Jul. 3, 2024, which is based on and claims the benefit of a Korean patent application number 10-2023-0087377, filed on Jul. 5, 2023, in the Korean Intellectual Property Office, and of a Korean patent application number 10-2023-0100311, filed on Aug. 1, 2023, in the Korean Intellectual Property Office, the disclosure of each of which is incorporated by reference herein in its entirety.

### BACKGROUND

### 1. Field

The disclosure relates to an electronic device and a method for optimizing applications.

### 2. Description of Related Art

When an application is installed in an electronic device, codes written in a programming language may be converted to be compatible with a platform supported by the electronic device, and the converted codes may be used as an instruction set for achieving a specific purpose. For example, in an electronic device to which an Android operating system is applied, codes of an application may be compiled to fit a runtime environment and converted into execution codes (native codes). Compiling may be converting source codes or byte codes into native codes.

The above information is presented as background information only to assist with an understanding of the disclosure. No determination has been made, and no assertion is made, as to whether any of the above might be applicable as prior art with regard to the disclosure.

### SUMMARY

In a hybrid scheme, codes of an application may be compiled when an execution condition (e.g., a charging state, an idle state, or a state in which a designated time, such as once per day, has arrived) is satisfied.

If an execution condition for optimizing an application is not satisfied for a long time due to a user's usage pattern, an electronic device including the hybrid scheme has a problem in that it is difficult to optimize the application.

Aspects of the disclosure are to address at least the above-mentioned problems and/or disadvantages and to provide at least the advantages described below. Accordingly, an aspect of the disclosure is to provide an electronic device and a method for optimizing an application of an electronic device, which generates execution code by using a hybrid scheme, to optimize an application or a package while charging.

Another aspect of the disclosure is to provide an electronic device and a method for optimizing an application of an electronic device, which generates execution code by using a hybrid scheme, to optimize an application or a package while controlling a heat generation state.

Additional aspects will be set forth in part in the description which follows and, in part, will be apparent from the description, or may be learned by practice of the presented embodiments.

In accordance with an aspect of the disclosure, an electronic device is provided. The electronic device includes at least one processor including processing circuitry, a battery, and memory storing instructions, wherein the instructions, when executed by the at least one processor individually or collectively, cause the electronic device to identify whether a state of the electronic device corresponds to an application optimization execution condition, identify whether a power level of the battery being charged is lower than or equal to a designated power level, in case that the power level of the battery being charged is lower than or equal to the designated power level, generate a list of applications to execute application optimization, identify information on temperature of the electronic device, execute application optimization, based on the list and the temperature, wherein the executing of the application optimization based on the list, includes adjusting the number of applications to be optimized, wherein the executing of the application optimization, based on the temperature, includes performing control to execute rescheduling in case that current temperature of the electronic device exceeds a designated temperature.

In accordance with another aspect of the disclosure, a method performed by an electronic device for optimizing an application is provided. The method includes identifying, by the electronic device, whether a state of the electronic device corresponds to an application optimization execution condition, identifying, by the electronic device, whether a power level of the battery being charged is lower than or equal to a designated power level, in case that the power level of the battery being charged is lower than or equal to the designated power level, generating, by the electronic device, a list of applications for which application optimization is to be executed, identifying, by the electronic device, information on a temperature of the electronic device, and executing, by the electronic device, application optimization based on the list and the temperature, wherein the executing of the application optimization, based on the list, comprises adjusting the number of applications to be optimized, and wherein the executing of the application optimization, based on the temperature, comprises performing control to execute rescheduling in case that the current temperature of the electronic device exceeds a designated temperature.

In accordance with another aspect of the disclosure, one or more non-transitory computer-readable recording media storing one or more computer programs including electronic device-executable instructions that, when executed by one or more processors of an electronic device individually or collectively, cause the electronic device to perform operations are provided. The operation s include identifying, by the electronic device, whether a state of the electronic device corresponds to an application optimization execution condition, identifying, by the electronic device, whether a power level of a battery being charged is lower than or equal to a designated power level, in case that the power level of the battery being charged is lower than or equal to the designated power level, generating, by the electronic device, a list of applications for which application optimization is to be executed, identifying, by the electronic device, information on temperature of the electronic device, and executing, by the electronic device, application optimization, based on the list and the temperature, and wherein the executing of the application optimization, based on the list includes adjusting the number of applications to be optimized, and the executing of the application optimization based on the temperature includes controlling to perform rescheduling in case that the current temperature of the electronic device is higher than a designated temperature.

An electronic device and a method for optimizing an application according to an embodiment of the disclosure can improve performance of an electronic device by optimizing an application while maintaining a charging state of the electronic device and suppressing heat generation.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of a program according to an embodiment of the disclosure;

FIG. 3 is a diagram illustrating a method of compiling an application and acquiring compiled packages according to an embodiment of the disclosure;

FIG. 4 is a diagram for describing an ahead-of-time (AOT) scheme, a just-in-time (JIT) scheme, and/or a hybrid scheme of an electronic device according to an embodiment of the disclosure; and

FIG. 5 is a flowchart illustrating a method for optimizing an application of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

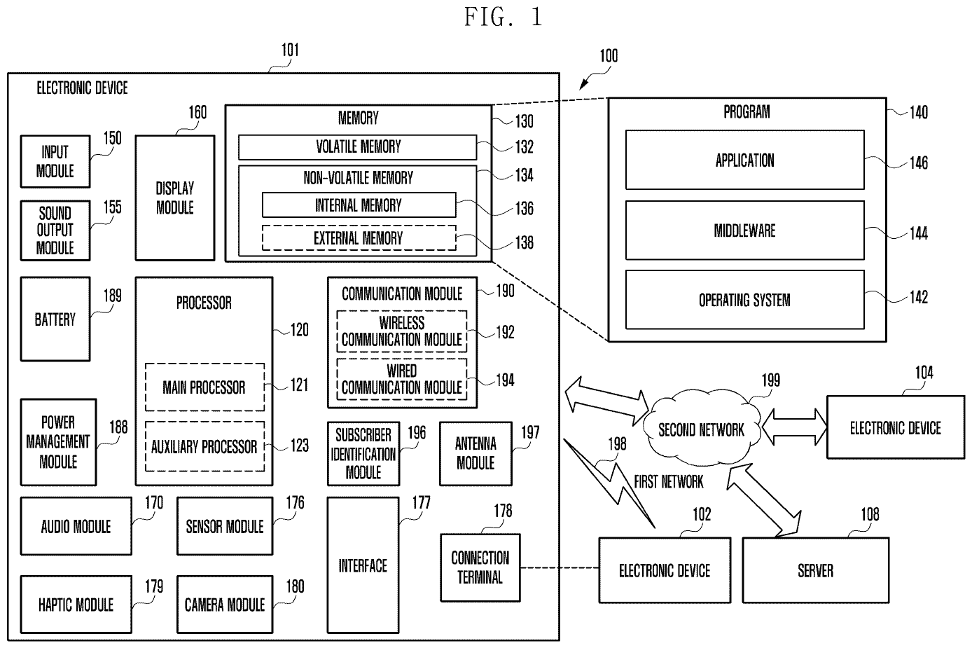

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

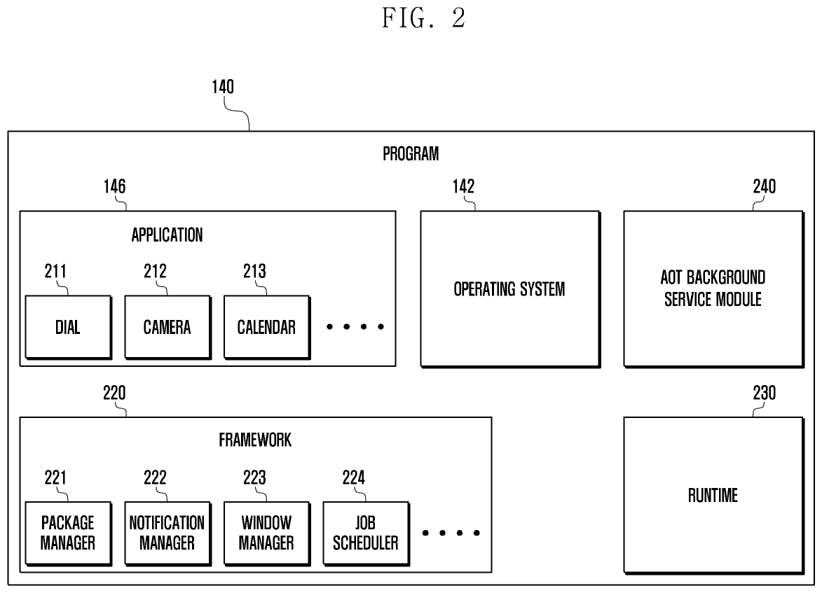

FIG. 2 is a block diagram of a program according to an embodiment of the disclosure.

Referring to FIG. 2, the program 140 may be stored in the memory 130. When executed under control of the processor 120, the program 140 stored in the memory 130 may cause the electronic device 101 to execute instructions included in the program 140.

In an embodiment, the program 140 may include an operating system 142, an application 146, a framework 220, a runtime 230, and/or an ahead-of-time (AOT) background service module 240. At least a part of the program 140 may be, for example, preloaded into the electronic device 101 at the time of manufacturing, or may be downloaded or updated from an external electronic device (e.g., the electronic device 102 or 104 or the server 108) by a user during use. An ahead-of-time (AOT) scheme, a just-in-time (JIT) scheme, or a hybrid scheme in which the AOT scheme and the JIT scheme are combined is used for a scheme for compiling codes.

The AOT scheme is a scheme in which codes are compiled, converted into executable codes, and stored during application installation, and the converted executable codes are directly read during application execution. In the AOT scheme, since the codes are already converted into executable codes during application installation, the time for executing the application may be shortened. However, the installation of the application may take a long time, and a large amount of storage space may be required to install the application.

The JIT scheme is a scheme in which, when the application is executed, only necessary code among codes is compiled at an appropriate time point. In the JIT scheme, while an operation is being performed for a loaded class among codes in an interpreter scheme, if repeated execution is detected, a JIT compiler may appropriately operate to improve execution speed. That is, since the time for executing executable codes is very short, and memory caching is performed by default, performance may be maximized when a class is repeatedly called. However, in the JIT scheme, since codes are compiled into the executable codes during runtime, the installation time of the application may be shortened, but the execution of the application may take a long time. In addition, when codes cached in the memory are released, if re-execution of the codes is detected, time is required for re-conversion of the codes, so that a delay may occur in the operation of the application.

In the hybrid scheme, the JIT scheme may be used during application installation to shorten the installation time and reduce the installation space of the application; a profile according to a user pattern is stored via an interpreter, and then when an execution condition is satisfied, an AOT background daemon may be started by a job scheduler to perform compiling in the background to generate executable code; and an execution time may be shortened by directly using the executable code during application execution.

In a recent electronic device to which an Android operating system is applied, an execution environment referred to as Android runtime (ART) is supported, and ART may use the hybrid scheme. ART uses a tool referred to as dex2oat to compile a dex (dalvik executable) file (a set of codes) of an application, in which case, an operation method may be designated by a configuration value of a compile filter, and the compile filter may be configured based on a profile according to a user pattern. That is, in ART, the codes of the application may be compiled according to the compile filter configured based on the profile according to the user pattern.

In an embodiment, the operating system 142 may control management (e.g., allocation or recovery) of one or more system resources (e.g., the process 120, the memory 130, or power) of the electronic device 101. For example, the operating system 142 may be Android™, iOS™, and/or Windows™. The operating system 142 may control an environment for executing not only hardware but also software such as an application.

In an embodiment, the application 146 may be composed of multiple codes for achieving a specific purpose, and may be packaged and distributed. The application 146 may include multiple applications. For example, the application 146 may include a dial 211, a camera 212, and/or a calendar 213 application. However, the disclosure is not limited thereto, and the application 146 may further include applications, such as game, home, short message service (SMS)/multimedia messaging service (MMS), instant message (IM), browser, alarm, contact, email, health, clock, album, voice recognition, and/or environmental information.

In an embodiment, the framework 220 may provide the application 146 with a function or information provided from one or more resources of the electronic device 101.

In an embodiment, the framework 220 may include a package manager 221, a notification manager 222, a window manager 223, and/or a job scheduler 224. However, the disclosure is not limited thereto, and the framework 220 may further include a resource manager, an activity manager, and a content provider.

In an embodiment, the package manager 221 may manage installation and/or update of an application distributed in the form of a package file. The application may be distributed in the form of a package file (e.g., an apk file), and the package manager 221 may parse a package, separate code and data included in the package, and store the same in the memory 130, under control of the processor 120.

In an embodiment, a package file may be a set of multiple instructions, and may refer to a group of one or more files or a file in which one or more files are compressed, both stored in the memory in order to execute an application.

In an embodiment, the instructions may include native code. For example, the instructions may be included in a binary file stored in the memory 130, and may be at least a part of machine language encoded in a binary format and/or assembly language. For example, the instructions may include instructions generated by compiling other instructions.

For example, the other instructions may be composed of source code and/or byte code. For example, the source code may include C language, JAVA language, and/or beginner's all-purpose symbolic instruction code (BASIC). However, the disclosure is not limited thereto. For example, the instructions may refer to instructions, such as byte code, readable by an interpreter and/or a virtual machine (e.g., Java virtual machine (JVM)) which are software executed by a processor. The byte code may be an instruction having a designated length (e.g., 1 byte). Hereinafter, a package may refer to a set of instructions.

In an embodiment, one or more files compressed in a package may include data required for execution of an application corresponding to the package. For example, the one or more files may include at least one of one or more resources (e.g., icons, images, and/or videos) required for execution of the application, a design element (e.g., an xml file for defining an activity), and/or metadata (e.g., an xml file having a designated name such as manifest).

In an embodiment, when at least one of applications is executed, the package manager 221 may store recent execution time information of the application in the memory 130 under control of the processor 120.

In an embodiment, in the electronic device 101 to which the Android operating system is applied, the package manager 221 may, when at least one application is executed, classify an execution time of the application via an API and store the same in the memory 130 under control of the processor 120. For example, the electronic device 101 may classify the execution time by reason, manage the execution time as a timestamp, and store the execution time in the memory 130 via a notifyPackageUse API. For example, the reason may be information related to an execution history of the application.

In an embodiment, the runtime 230 may store, under control of the processor 120, a user-based profile for each application in the memory 130 according to a usage pattern of a user. For example, the usage pattern may relate to a sequence of applications frequently used by the user.

In an embodiment, the notification manager 222 may provide a function for notifying a user of occurrence of a designated event (e.g., an incoming call, a message, or an alarm).

In an embodiment, the window manager 223 may manage resources related to one or more graphic user interfaces, localized character strings, graphics, and layouts used in a screen displayed on a display (e.g., the display module 160).

In an embodiment, the resource manager may manage source code of the application 1460 or a storage space of the memory 130, and the activity manager may manage a life cycle of the application. The content provider may support an application to share data of the application or to access data of another application.

In an embodiment, the job scheduler 224 may include a job service and a job info.

In an embodiment, job may be a task or execution unit in computing processing. The job scheduler 224 may perform processing on execution operations of jobs according to circumstances. For example, the job scheduler 224 may determine, according to circumstances, jobs to be executed, whether to defer a job, whether to operate a job in the background, or whether to execute jobs in sequence.

In an embodiment, the job scheduler 224 may define, in the job service, content to be performed during execution of a job and define, in the job info, a situation for executing the job.

In an embodiment, the job scheduler 224 may call different functions according to situations, such as job start, completion, or interruption. For example, when executing a scheduled job, the job scheduler may call a specific function (onStartJob) defined in the job service. The job scheduler 224 may call a specific function (onStopJob) when a job needs to be stopped. When a scheduled job is completed or interrupted, the job scheduler 224 may call a specific function (JobFinished) in the job service to notify the job scheduler that the job has ended. When a job is interrupted, the job scheduler 224 may identify a reason for interruption and reschedule the interrupted job.

In an embodiment, the job scheduler 224 may manage a background job to be performed under the execution condition. For example, the job scheduler 224 may activate the ahead-of-time (AOT) daemon or the AOT background service module 240 under the execution condition, and control codes of the application 146 to be compiled via the AOT background service module 240. The daemon may include a process that is automatically executed at booting to provide an application service in the background and continues to run in the background.

In an embodiment, under an interrupt condition, the job scheduler 224 may interrupt a background job to be performed and perform rescheduling.

In an embodiment, the job scheduler 224 may define and/or store information on the execution condition in the job info under control of the processor 120.

In an embodiment, the job scheduler 224 may define and/or store a background job to be performed in the job service under control of the processor 120.

In an embodiment, the execution condition may be a condition related to a state and/or execution period of the electronic device 101 for executing application optimization.

In an embodiment, the electronic device 101 may execute the job scheduler 224 and/or the AOT background service module 240 in the execution period (e.g., 24 hours) under control of the processor 120. For example, the electronic device 101 may execute, under control of the processor 120, the job scheduler 224 and/or the AOT background service module 240 once per execution period to compile the application 146. In an embodiment, the state of the electronic device 101 may be a charging state and/or an idle state of the electronic device. For example, the charging state of the electronic device 101 may be a state in which the electronic device 101 is supplied with power from an external power source and charges the battery 189, and/or a state including information on a charging level of a total capacity of the battery 189.

In an embodiment, under control of the processor 120, the electronic device 101 may execute the job scheduler 224 and/or the AOT background service module 240, based on maintenance of the optimization execution condition.

For example, the charging state of the electronic device 101 may be a state in which, when the electronic device 101 is supplied with power from an external power source and charges the battery 189, the charging is performed up to a designated level (e.g., 80% of a fully charged power level) or lower based on a power level at the full charge of the battery 189.

In an embodiment, if the electronic device 101 is supplied with power from an external power source and charges the battery 189, the processor 120 may determine that the electronic device 101 is in a charging state.

In an embodiment, if the electronic device 101 is supplied with power from an external power source and charges the battery 189, and the charging is performed to the designated level (e.g., 80% of the fully charged power level) or lower based on a power level at the full charge of the battery 189, the processor 120 may determine that the electronic device 101 is in a charging state.

In an embodiment, the processor 120 may determine that the electronic device 101 is in an idle state when the display (e.g., the display module 160) of the electronic device 101 is turned off and a designated time (e.g., 31 minutes after being turned off) elapses. However, the disclosure is not limited thereto, and the idle state of the electronic device 101 may be independent of on or off of the display. For example, the processor 120 may determine that the electronic device 101 is in an idle state when a process running on the electronic device 101 uses resources equal to or lower than a certain level.

In an embodiment, when the execution period arrives based on the execution condition, and the electronic device 101 is in a charging state and is in an idle state, application optimization may be performed under control of the processor 120.

For example, applications installed in the electronic device 101 according to the hybrid scheme (e.g., applications included in the application 146) may generate a compiled file (e.g., an oat file or an odex file) by compiling at least one code of the application 146 via the AOT daemon or the AOT background service module 240 under the execution condition. The runtime 230 may execute applications by using at least one compiled file. However, if there is an update (e.g., an over-the-air (OTA) update and/or a mainline update) of the operating system 142, the framework 220, the application 146, and/or the program 140, a compiled file cannot be used, so that it is necessary to recompile the codes of the application 146 via the AOT background service module 240. According to an embodiment, recompiling of the codes of the application 146 via the AOT background service module 240 due to the update of the operating system 142, the framework 220, the application 146, and/or the program 140 may be referred to as application optimization and/or package optimization.

In an embodiment, the interrupt condition may be a condition related to a state of the electronic device 101 for interrupting application optimization that is being executed.

In an embodiment, the interrupt condition may be a state in which the electronic device 101 is out of a charging state or an idle state.

In an embodiment, the interrupt condition may be a state in which an application optimization time for the electronic device 101 exceeds a designated time (e.g., 10 minutes).

In an embodiment, the interrupt condition may be a state in which the battery 189 is being charged to a level higher than the designated level (e.g., 80% of the fully charged power level) based on the power level at the full charge of the battery 189.

In an embodiment, the interrupt condition may be a state in which the current temperature of the electronic device 101 is higher than a designated temperature (e.g., 40° C.). A temperature or surface temperature of the electronic device 101 may be measured based on a temperature sensor included in the electronic device 101. The current temperature of the electronic device 101 may be a temperature (e.g., surface temperature) measured while executing application optimization.

In an embodiment, the interrupt condition may be a state in which the current temperature of the electronic device 101 is higher than a designated range from a temperature identified before executing the application optimization. The identified temperature may be a temperature (e.g., surface temperature) of the electronic device 101.

For example, if the temperature of the electronic device 101 identified before executing the application optimization is 36° C., the designated range may be 1.0° C. If the current temperature of the electronic device 101 after executing the application optimization is higher than 37° C., the electronic device 101 may interrupt the application optimization, under control of the processor 120. The electronic device 101 may store, in the memory 130, the temperature (e.g., surface temperature) of the electronic device 101 identified before executing the application optimization.

Table 1 may represent the temperature (e.g., surface temperature) of the electronic device 101 identified before executing the application optimization and the designated range according to an embodiment.

TABLE 1

| Temperature (e.g., surface | |
|---|---|
| temperature) of the electronic | |
| device 101 identified before | |
| executing application | Designated |
| optimization | range |
| 36° C. or lower | Within 1.0° C. change from |
| | the identified temperature |
| Higher than 36° C. and | Within 0.8° C. change from |
| 37° C. or lower | the identified temperature |
| Higher than 37° C. and | Within 0.5° C. change from |
| 38° C. or lower | the identified temperature |
| Higher than 38° C. and | Within 0.2° C. change from |
| 39° C. or lower | the identified temperature |
| Higher than 39° C. | Temperature (e.g., surface |
| | temperature) of the electronic |
| | device 101 after executing |
| | application optimization is |
| | 40° C. or lower. |

In an embodiment, the interrupt condition may be a state in which an available storage space in the memory 130 of the electronic device 101 is smaller than a designated size (e.g., 5% of a total memory size). In an embodiment, the job scheduler 224 may select, based on an application optimization list, applications to be optimized according to a specific condition (e.g., the temperature of the electronic device 101).

For example, if the temperature (e.g., surface temperature) of the electronic device 101 is higher than a designated temperature (e.g., 39° C.), the job scheduler 224 may adjust the AOT background service module 240 to perform optimization only for several (e.g., five) applications included at the top of the list.

In an embodiment, when the designated level (e.g., 80% of the fully charged power level) is exceeded based on the power level at the full charge of the battery 189, full charging of the battery 189 may be expected. In this case, the job scheduler 224 may perform rescheduling to enable optimization to be performed for all applications when the battery 189 is fully charged.

In an embodiment, the job scheduler 224 may perform rescheduling so that the AOT background service module 240 executes optimization for several (e.g., five) applications included at the top of the list regardless of the power level of the battery 189.

In an embodiment, the job scheduler 224 may adjust, according to a charging phase of the battery 189, the number of applications to be optimized based on the application optimization list.

For example, the charging phase of the battery 189 may include a constant current (CC) phase or a constant voltage (CV) phase. The package manager 221 or the AOT background service module 240 may generate, define, and/or store a list to enable more applications to be optimized when the charging phase of the battery 189 is in the constant voltage (CV) phase rather than in the constant current (CC) phase. For example, the charging phase of the battery 189 may include the constant current (CC) phase in which charging is performed with a designated ampere to continuously flow a constant current, or the constant voltage (CV) phase in which charging is performed with a designated voltage to maintain a constant voltage. When an appropriate battery voltage is reached, the voltage is fixed and current flows, so that heat generation may be reduced and more applications may be optimized.

In an embodiment, the package manager 221 or the AOT background service module 240 may acquire information on the charging phase of the battery 189 and/or information on the charging level of the battery 189 via a battery manager that is a system service.

In an embodiment, when rescheduling for application optimization is repeated more than a designated number of times (e.g., three times), the job scheduler 224 may perform, under control of the processor 120, the job service (e.g., application optimization) in a subsequent execution period (e.g., after 24 hours) without rescheduling.

In an embodiment, the runtime 230 may be a library or a program of base code used by a compiler or a virtual machine to manage the program 140. The electronic device 101 may include Android runtime (ART) as the runtime 230.

In an embodiment, the runtime 230 may be a runtime used in the application 146 and the system service, may compile a dex file by using a dex2oat tool to generate an oat file, and may directly execute the application 146 by using the oat file when executing the application 146. The runtime 230 may perform ahead-of-time (AOT) compilation.

In an embodiment, the electronic device 101 to which an Android operating system is applied may support an execution environment referred to as Android Runtime (ART). ART may use the hybrid scheme. In an embodiment, ART may use a tool referred to as dex2oat to compile a dex file of an application executable on Dalvik (Android virtual machine), in which case, an operation scheme thereof may be designated by a configuration value of a compiler filter, and the compiler filter may be configured based on a profile according to an application usage pattern of a user. In ART, codes of the application may be compiled according to the configured compiler filter.

For example, in the electronic device 101 to which the Android operating system is applied, the processor 120 may compile codes of the application according to a runtime environment and convert the codes into native codes. An ahead-of-time (AOT) scheme, a just-in-time (JIT) scheme, or a hybrid scheme in which the AOT scheme and the JIT scheme are combined may be used for a scheme for compiling codes.

Under control of the processor 120, the electronic device 101 may, during installation of the application 146, convert second-type instructions (e.g., source code, byte code, and interpreter- and virtual machine-readable instructions) included in the application 146 into first-type instructions (native codes) and store the same. For example, converting the second-type instructions into the first-type instructions and storing the same at a time of installing packages may be referred to as an ahead-of-time (AOT) scheme.

The AOT scheme is a scheme in which codes are compiled, converted into executable codes, and stored during application installation, and the converted executable codes are directly read during application execution. In the AOT scheme, since the codes are already converted into executable codes during application installation, the time for executing the application may be shortened. However, the installation of the application may take a long time, and a large amount of storage space may be required to install the application.

The JIT scheme is a scheme in which, when the application is executed, only necessary code among codes is compiled at an appropriate time point. In the JIT scheme, while an operation is being performed for a loaded class among codes in an interpreter scheme, if repeated execution is detected, a JIT compiler may appropriately operate to improve execution speed. That is, since the time for executing executable codes is very short, and caching in the memory 130 is performed by default, performance may be maximized when a class is repeatedly called. For example, since a part of the memory 130 includes a JIT cache code area, and code is executed based on the JIT cache code via the JIT scheme, performance is maximized. However, in the JIT scheme, since codes are compiled into executable codes during runtime, an installation time of the application may be shortened, but execution of the application may take a long time. In addition, when codes cached in the memory 130 are released, if re-execution of the codes is detected, time to re-convert the codes is required, so that a delay may occur in operation of the application. For example, when re-execution of the codes is detected, codes stored in the JIT cache code area included in the memory 130 may be moved back to the memory 130, and then when re-execution of the codes is detected again, a time for reading the codes into the cache memory or for reconverting the codes is required, so that a delay may occur in operation of the application.

In the hybrid scheme, during installation of the application, the JIT scheme may be used to shorten an installation time for the application and to reduce an installation space. In the hybrid scheme, after storing a profile according to an application usage pattern of a user via the interpreter, when the execution condition is satisfied, the AOT background service module 240 may start to compile the application in the background to generate executable codes, and the executable codes may be directly used during execution of the application. For example, compiling within the execution condition may include the hybrid scheme (e.g., a combination of the AOT and JIT schemes).

In an embodiment, the runtime 230 may determine whether optimization is required for the application 146. For example, the runtime 230 may determine, based on a profile according to a user pattern, whether optimization for the application 146 is required.

In an embodiment, the AOT background service module 240 may be executed by the job scheduler 224, and may operate as a background service. The AOT background service module 240 may compile, using a dex2oat tool, a dex file existing in an apk file that is a package form of the application 146. The dex file compiled by the AOT background service module 240 may be generated as an oat file.

In an embodiment, the AOT background service module 240 may perform or interrupt application optimization based on the application optimization list and the job scheduler 224.

In an embodiment, under control of the processor 120, the package manager 221 or the AOT background service module 240 may define and/or store an application optimization list for which application optimization is to be executed.

In an embodiment, under control of the processor 120, the package manager 221 or the AOT background service module 240 may generate, define, and/or store an application optimization list for which application optimization is to be executed, based on a user profile for each application stored by the package manager 221.

In an embodiment, the package manager 221 or the AOT background service module 240 may exclude an application or package without byte code from the application optimization list for which application optimization is to be executed.

In an embodiment, the package manager 221 or the AOT background service module 240 may exclude an application or package in a maximum power saving mode (e.g., hibernation) from the application optimization list for which application optimization is to be executed. For example, an application may be regarded as being in a hibernation state if the application is not used for a designated period (e.g., 90 days). For example, in order to reduce power consumption, when an application or a package is in a hibernation state, the electronic device may perform an operation for reducing power consumption without executing the application or package.

In an embodiment, the package manager 221 or the AOT background service module 240 may generate, define, and/or store a list by arranging, in a recent execution order, applications or packages including a foreground activity and/or a service executed within a designated time (e.g., three days).

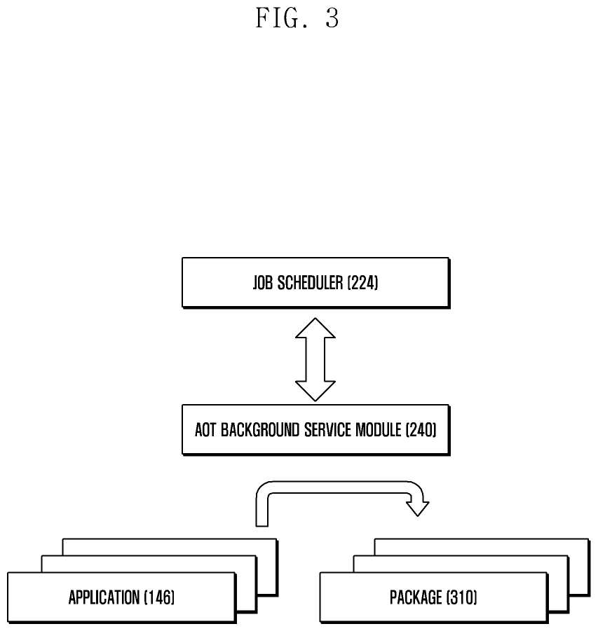

FIG. 3 is a diagram illustrating a method of compiling an application (e.g., the application 146) and acquiring compiled packages according to an embodiment of the disclosure.

Referring to FIG. 3, the electronic device 101 may compile the application 146 based on the job scheduler 224 and/or the AOT background service module 240 under control of the processor 120, and may acquire compiled packages 310. For example, the application 146 may include second-type instructions, such as byte code. For example, the compiled packages 310 may include first-type instructions, such as native code.

In an embodiment, the electronic device 101 may execute the first-type instructions under control of the processor 120. For example, the first-type instructions may include native code. For example, the first-type instructions may be included in a binary file stored in the memory 130, and may be at least a part of machine language encoded in a binary format and/or assembly language. For example, the first-type instructions may include instructions generated by compiling the second-type instructions.

For example, the second-type instructions may consist of source code and/or byte code. For example, the source code may include C language, JAVA language, and/or beginner's all-purpose symbolic instruction code (BASIC). However, the disclosure is not limited thereto. For example, the second-type instructions may indicate instructions, such as byte code, readable by an interpreter and/or a virtual machine (e.g., Java virtual machine (JVM)) which are software executed by the processor 120. The byte code may be an instruction having a designated length (e.g., 1 byte). Hereinafter, a package may be a set of the second-type instructions, and may refer to a group of one or more files (or a single file in which the one or more files are compressed) stored in the memory 130 in order to execute an application.

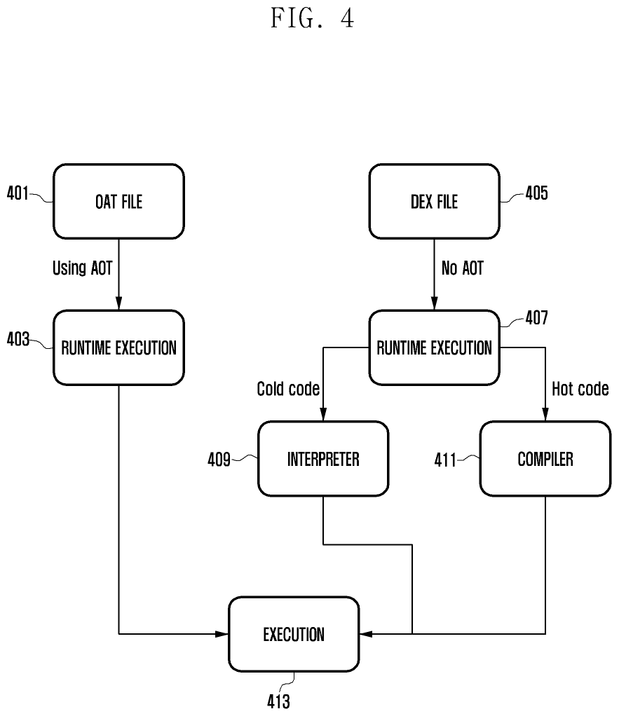

FIG. 4 is a diagram for describing an AOT scheme, a JIT scheme, and/or a hybrid scheme of an electronic device according to an embodiment of the disclosure.

Referring to FIG. 4, the runtime 230 may be a library or a program of base code used by a compiler or a virtual machine to manage the program 140. The electronic device 101 may include Android runtime (ART) as the runtime 230.

In an embodiment, the runtime 230 may be a runtime used for the application 146 and the system service, and may generate an oat file by compiling a dex file using a dex2oat tool.

In an embodiment, under control of the processor 120, in operation 401, the electronic device 101 may use an oat file when executing the application 146.

In an embodiment, under control of the processor 120, in operation 403, the electronic device 101 may cause the runtime 230 to perform ahead-of-time (AOT) compilation. Under control of the processor 120, in operation 405, the electronic device 101 may perform ahead-of-time (AOT) compilation to execute the application 146.

During initial installation of the application, for example, converting second-type instructions into first-type instructions and storing the same may be referred to as an ahead-of-time (AOT) scheme.

Under control of the processor 120, in operation 405, during the initial installation of the application, the electronic device 101 may use a dex file for application installation. Under control of the processor 120, in operation 407, the electronic device 101 may identify whether the runtime 230 is for the initial installation of the application. Under control of the processor 120, in operation 411, if the runtime 230 is for the initial installation of the application, the electronic device 101 may compile the dex file by using a JIT compiler.

Referring to operations 405, 407, 411, and 413, during the initial installation of the application, the electronic device 101 may compile the dex file by using the JIT compiler and execute the application 146, under control of the processor 120.

If the runtime 230 is not for the initial installation of the application, the electronic device 101 may execute the dex file by using an interpreter in operation 409, under control of the processor 120.

Under control of the processor 120, in operation 409, the electronic device 101 may store a profile according to an application usage pattern of a user by using the interpreter.

After storing the profile according to the application usage pattern of the user via the interpreter, when an execution condition is satisfied, the electronic device 101 may start the AOT background service module 240 to compile the application in the background and generate executable codes.

In the hybrid scheme, the JIT scheme may be used during application installation to shorten an installation time and reduce an installation space of an application, and after storing a profile according to an application usage pattern of a user via the interpreter, when the execution condition is satisfied, the AOT background service module 240 may start to compile the application in the background to generate executable codes, and the executable codes may be directly used at during execution of the application.

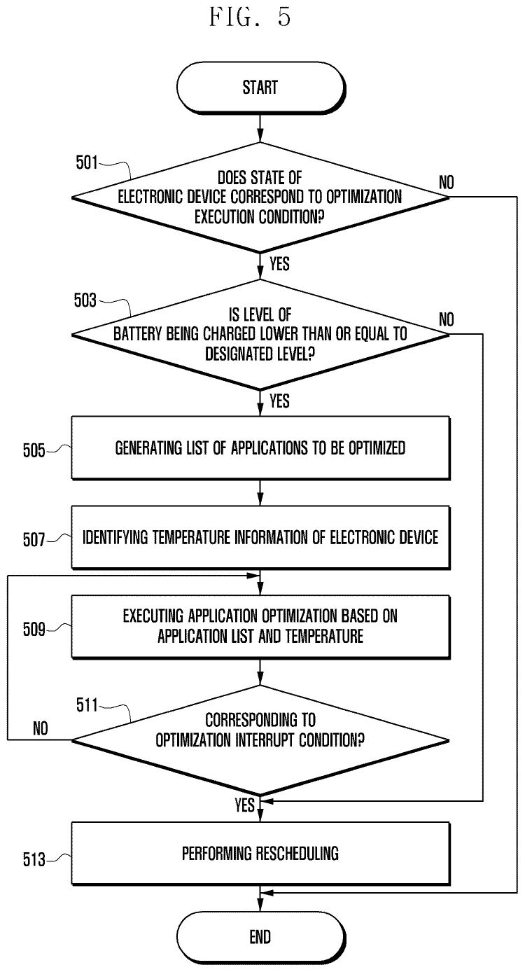

FIG. 5 is a flowchart illustrating a method for optimizing an application of an electronic device according to an embodiment of the disclosure.

Referring to FIG. 5, in operation 501, under control of the processor 120, the electronic device 101 may determine whether a state of the electronic device 101 corresponds to an application optimization execution condition.

In an embodiment, in operation 501, under control of the processor 120, the electronic device 101 may manage, based on the job scheduler 224, a background job to be performed under an execution condition.

In an embodiment, in operation 501, under control of the processor 120, the electronic device 101 may, based on the job scheduler 224, define and/or store information on the execution condition in job information.

In an embodiment, the execution condition may be a condition related to a state and/or execution period of the electronic device 101 for executing application optimization.

In an embodiment, the execution period may be one day (24 hours). For example, under control of the processor 120, the electronic device 101 may determine that optimization execution is required according to the execution period when the execution period is configured to one day.

In an embodiment, the state of the electronic device 101 may be a charging state and/or idle state of the electronic device. The charging state may include a state in which the electronic device 101 is being charged. For example, under control of the processor 120, the electronic device 101 may determine that optimization execution is required for a charging state and/or idle state of the electronic device 101.

In an embodiment, in operation 501, under control of the processor 120, the electronic device 101 may determine that the electronic device 101 is in a charging state if the electronic device 101 receives power from an external power source to charge the battery 189.

In an embodiment, in operation 501, under control of the processor 120, the electronic device 101 may determine that the electronic device 101 is in an idle state if a display (e.g., the display module 160) of the electronic device 101 is turned off and a designated time (e.g., 31 minutes after being turned off) has elapsed. However, the disclosure is not limited thereto, and the idle state of the electronic device 101 may be independent of on or off of the display. For example, in operation 501, under control of the processor 120, the processor 120 may determine that the electronic device 101 is in an idle state when a process running on the electronic device 101 uses resources equal to or lower than a certain level. For example, the idle state may include a state in which interaction between the electronic device 101 and a user does not occur for the designated period (e.g., 31 minutes) or longer. For example, the execution condition may include a state in which the battery 189 of the electronic device 101 is being charged by an external object and the display (e.g., the display module 160) is turned off. For example, the idle state of the electronic device 101 may include a state of displaying a screen related to the idle state on the display (e.g., the display module 160), based on execution of an always-on-display (AOD) function.

In an embodiment, under control of the processor 120, the electronic device 101 may generate an oat/art file if the application optimization execution condition is satisfied, i.e., the electronic device 101 is being charged and is in an idle state, and a once-a-day condition is satisfied.

In an embodiment, if the state of the electronic device 101 corresponds to the application optimization execution condition, the electronic device 101 may branch from operation 501 to operation 503.

In an embodiment, if the state of the electronic device 101 does not correspond to the application optimization execution condition, the application optimization of the electronic device 101 may be terminated, and an ongoing job may continue.

In an embodiment, in operation 503, under control of the processor 120, the electronic device 101 may identify whether a power level of the battery 189 being charged is lower than or equal to a designated power level.

In an embodiment, in operation 503, under control of the processor 120, the electronic device 101 may acquire information on a charging phase of the battery 189 and/or information on a charging level of the battery 189 via a battery manager that is a system service.

For example, the charging state of the electronic device 101 may be a state in which the electronic device 101 receives power from an external power source to charge the battery 189.

In an embodiment, when the electronic device 101 receives power from the external power source to charge the battery 189, the electronic device 101 may determine, in operation 503, under control of the processor 120, whether the battery 189 is charged to a designated level (e.g., 80% of a fully charged power level) or lower based on the power level at the full charge of the battery 189.

In an embodiment, in operation 503, under control of the processor 120, the electronic device 101 may identify whether the power level of the battery 189 being charged is lower than or equal to the designated power level each time when optimization is performed based on a list of applications for which application optimization is to be executed.

In an embodiment, if the level of the battery 189 being charged is lower than or equal to the designated level, the electronic device 101 may branch from operation 503 to operation 505.

In an embodiment, if the level of the battery 189 being charged higher the designated level, the electronic device 101 may branch from operation 503 to operation 513.

In an embodiment, in operation 505, under control of the processor 120, the electronic device 101 may generate a list of applications for which application optimization is to be executed.

However, the disclosure is not limited thereto, and the electronic device 101 may previously generate a list of applications for which application optimization is to be executed. If the electronic device 101 has previously generated a list of applications for which application optimization is to be executed, operation 505 may be omitted.

In an embodiment, in operation 505, under control of the processor 120, the electronic device 101 may generate, define, and/or store an application optimization list for which application optimization is to be executed, based on a user profile for each application stored by the package manager 221.

In an embodiment, in operation 505, under control of the processor 120, the electronic device 101 may exclude an application or package without byte code from the application optimization list for which application optimization is to be executed.

In an embodiment, in operation 505, under control of the processor 120, the electronic device 101 may exclude an application or package in a hibernation state from the application optimization list for which application optimization is to be executed.

In an embodiment, in operation 505, under control of the processor 120, the electronic device 101 may generate, define, and/or store a list by arranging, in a recent execution order, applications or packages including a foreground activity and/or a service executed within a designated time (e.g., three days).

In an embodiment, in operation 505, under control of the processor 120, the electronic device 101 may adjust the number of applications to be optimized, based on the application optimization list.

In an embodiment, before performing the application optimization, if temperature (e.g., surface temperature) of the electronic device 101 is lower than or equal to a designated temperature (e.g., 39° C.), the electronic device 101 may cause, in operation 505, under control of the processor 120, the AOT background service module 240 to perform optimization for applications included in the list.

In an embodiment, if the temperature (e.g., surface temperature) of the electronic device 101 is higher than the designated temperature (e.g., 39° C.), the electronic device 101 may perform adjustment, in operation 505, under control of the processor 120, so that the AOT background service module 240 performs optimization only for several (e.g., five) applications included at the top of the list.

In an embodiment, in operation 505, under control of the processor 120, the electronic device 101 may adjust the number of applications to be optimized, based on the application optimization list according to the charging phase of the battery 189.

For example, the charging phase of the battery 189 may include a constant current (CC) phase or a constant voltage (CV) phase. In an embodiment, in operation 303, under control of the processor 120, the electronic device 101 may generate the list such that more applications are optimized when the charging phase of the battery 189 is in the constant voltage (CV) phase rather than in the constant current (CC).

In an embodiment, in operation 507, under control of the processor 120, the electronic device 101 may identify the temperature of the electronic device 101.

In an embodiment, in operation 507, under control of the processor 120, the electronic device 101 may identify the temperature of the electronic device 101, temperature information, the temperature (e.g., surface temperature) of the electronic device 101, and/or a surface temperature of the battery 189.

The temperature or surface temperature of the electronic device 101 may be measured based on a temperature sensor included in the electronic device 101.

In an embodiment, in operation 507, under control of the processor 120, the electronic device 101 may store, in the memory 130, information on the identified temperature (e.g., surface temperature) of the electronic device 101.

In an embodiment, in operation 509, under control of the processor 120, the electronic device 101 may execute application optimization based on the application optimization list and the identified temperature.

In an embodiment, in operation 509, under control of the processor 120, the electronic device 101 may sequentially execute application optimization based on the application optimization list and the identified temperature.

For example, in operation 509, under control of the processor 120, the electronic device 101 may sequentially optimize applications according to priorities in the application optimization list, and when application optimization is performed for one application, the electronic device 101 may branch from operation 509 to operation 511 to identify whether to interrupt application optimization.

In an embodiment, in order to reduce heat generation of the electronic device 101 due to application optimization and achieve stable charging of the battery 189, the electronic device 101 may sequentially optimize applications according to priorities in the application optimization list, and when application optimization is performed for one application, the electronic device 101 may identify whether to interrupt application optimization.

In an embodiment, applications installed in the electronic device 101 according to the hybrid scheme (e.g., applications included in the application 146) may generate a compiled file (e.g., an oat file or an odex file) by compiling codes of the application 146 via the AOT daemon or the AOT background service module 240 under the execution condition. The runtime 230 may execute the applications by using the compiled file. However, if there is an update (e.g., an over-the-air (OTA) update and/or a mainline update) of the operating system 142, the framework 220, the application 146, and/or the program 140, the compiled file cannot be used, so that it is necessary to recompile the codes of the application 146 via the AOT background service module 240. The operation of recompiling the codes of the application 146 via the AOT background service module 240 due to the update of the operating system 142, the framework 220, the application 146, and/or the program 140 may be referred to as an application optimization and/or package optimization operation.

In an embodiment, in operation 511, under control of the processor 120, the electronic device 101 may identify whether the state of the electronic device 101 corresponds to an application optimization interrupt condition.

In an embodiment, the interrupt condition may be a condition related to a state of the electronic device 101 for interrupting application optimization that is being executed.

If the state of the electronic device 101 corresponds to the application optimization interrupt condition, the electronic device 101 may branch from operation 511 to operation 513.

If the state of the electronic device 101 does not correspond to the application optimization interrupt condition, the electronic device 101 may branch from operation 511 to operation 509 to perform optimization for an application that has not been optimized in the application optimization list, wherein the application follows the application that has been optimized.

In an embodiment, in operation 513, under control of the processor 120, the electronic device 101 may interrupt the application optimization and perform rescheduling.

In an embodiment, in operation 513, under control of the processor 120, if rescheduling for application optimization is repeated a designated number of times (e.g., three times) or more, the electronic device 101 may execute application optimization in a subsequent execution period (e.g., after 24 hours) without rescheduling.

In an embodiment, the interrupt condition may be a state in which the electronic device 101 is out of a charging state or an idle state.

In an embodiment, the interrupt condition may be a state in which an application optimization time for the electronic device 101 exceeds a designated time (e.g., 10 minutes).

In an embodiment, the interrupt condition may be a state in which the battery 189 is being charged to a level higher than the designated level (e.g., 80% of the fully charged power level) based on the power level at the full charge of the battery 189.

In an embodiment, the interrupt condition may be a state in which the current temperature of the electronic device 101 is higher than a designated temperature (e.g., 40° C.). A temperature or surface temperature of the electronic device 101 may be measured based on a temperature sensor included in the electronic device 101. The current temperature of the electronic device 101 may be a temperature (e.g., surface temperature) measured while executing application optimization.

Referring to Table 1, the interrupt condition may be a state in which the current temperature of the electronic device 101 exceeds a designated range from a temperature identified before performing the application optimization. The identified temperature may be the temperature (e.g., surface temperature) of the electronic device 101.

In an embodiment, the interrupt condition may be a state in which an available storage space in the memory 130 of the electronic device 101 is smaller than a designated size (e.g., 5% of a total memory size).

In an embodiment, in operation 311, under control of the processor 120, the electronic device 101 may determine whether the current temperature of the electronic device 101 is lower than the designated temperature (e.g., 40° C.).

In an embodiment, if the current temperature of the electronic device 101 is lower than the designated temperature (e.g., 40° C.), the electronic device 101 may sequentially execute application optimization under control of the processor 120, based on the application optimization list and the identified temperature.

In an embodiment, if the current temperature of the electronic device 101 is higher than the designated temperature (e.g., 40° C.), the electronic device 101 may interrupt the application optimization and perform rescheduling, under control of the processor 120.

In an embodiment, in operation 311, under control of the processor 120, the electronic device 101 may determine whether the current temperature of the electronic device 101 is within the designated range from the temperature identified before performing the application optimization.

In an embodiment, if the current temperature of the electronic device 101 is within the designated range from the temperature identified before performing the application optimization, the electronic device 101 may sequentially execute application optimization under control of the processor 120, based on the application optimization list and the identified temperature.

In an embodiment, if the current temperature of the electronic device 101 exceeds the designated range from the temperature identified before performing the application optimization, the electronic device 101 may interrupt the application optimization and perform rescheduling, under control of the processor 120.

Referring to Table 1, if the temperature of the electronic device 101 identified before performing the application optimization is 36° C., the designated range may be 1.0° C. If the current temperature of the electronic device 101 after performing the application optimization is higher than 37° C., the electronic device 101 may interrupt the application optimization, under control of the processor 120.

Referring to Table 1, if the temperature of the electronic device 101 identified before performing the application optimization is 36.5° C., the designated range may be 0.8° C. If the current temperature of the electronic device 101 after performing the application optimization is higher than 37.3° C., the electronic device 101 may interrupt the application optimization, under control of the processor 120.

Referring to Table 1, if the temperature of the electronic device 101 identified before performing the application optimization is 37.5° C., the designated range may be 0.5° C. If the current temperature of the electronic device 101 after performing the application optimization is higher than 38° C., the electronic device 101 may interrupt the application optimization, under control of the processor 120.

Referring to Table 1, if the temperature of the electronic device 101 identified before performing the application optimization is 38.5° C., the designated range may be 0.2° C. If the current temperature of the electronic device 101 after performing the application optimization is higher than 38.7° C., the electronic device 101 may interrupt the application optimization, under control of the processor 120.

Referring to Table 1, if the temperature of the electronic device 101 identified before performing the application optimization is 39.5° C., the designated range may be 40° C. If the current temperature of the electronic device 101 after performing the application optimization is higher than 40° C., the electronic device 101 may interrupt the application optimization, under control of the processor 120.

In an embodiment, the electronic device 101 may include the at least one processor 120 including processing circuitry, the battery 189, and the memory 130.

In an embodiment, instructions stored in the memory 130, when individually or collectively executed by the at least one processor 120, may cause the electronic device 101 to perform: identifying whether a state of the electronic device 101 corresponds to an application optimization execution condition; identifying whether a power level of the battery 189 being charged is lower than or equal to a designated power level; if the power level of the battery 189 being charged is lower than or equal to the designated power level, generating a list of applications for which application optimization is to be executed; identifying information on temperature of the electronic device 101; and controlling application optimization to be performed based on the list and the temperature, wherein the executing of the application optimization based on the list includes adjusting the number of applications to be optimized, and the executing of the application optimization based on the temperature includes controlling to perform rescheduling if the current temperature of the electronic device is higher than a designated temperature.

In an embodiment, the instructions stored in the memory 130, when individually or collectively executed by the at least one processor 120, may cause the electronic device 101 to adjust the number of applications to be optimized based on the list, according to a charging phase of the battery 189.

In an embodiment, the instructions stored in the memory 130, when individually or collectively executed by the at least one processor 120, may cause the electronic device 101 to perform control to generate the list by arranging, in a recent execution order, applications including a foreground activity and/or a service executed within a designated time.

In an embodiment, the instructions stored in the memory 130, when individually or collectively executed by the at least one processor 120, may cause the electronic device 101 to control rescheduling to be performed if the power level of the battery 189 being charged is higher than the designated power level.

In an embodiment, the instructions stored in the memory 130, when individually or collectively executed by the at least one processor 120, may cause the electronic device 101 to control optimization to be performed for all applications if the power level of the battery 189 being charged is higher than the designated power level.

In an embodiment, the application optimization execution condition may be that the electronic device 101 is in a charging state and is in an idle state.

In an embodiment, the instructions stored in the memory 130, when individually or collectively executed by the at least one processor 120, may cause the electronic device 101 to sequentially execute application optimization based on the list and temperature, identify whether the state of the electronic device 101 corresponds to an application optimization interrupt condition, and control rescheduling to be performed if the state of the electronic device 101 corresponds to the interrupt condition.

In an embodiment, the instructions stored in the memory 130, when individually or collectively executed by the at least one processor 120, may cause the electronic device 101 to control rescheduling to be performed if the electronic device 101 is out of a charging state or an idle state.

In an embodiment, the instructions stored in the memory 130, when individually or collectively executed by the at least one processor 120, may cause the electronic device 101 to, after performing the application optimization for at least one application based on the list, control rescheduling to be performed if the current temperature of the electronic device 101 is higher than the designated temperature.

In an embodiment, the instructions stored in the memory 130, when individually or collectively executed by the at least one processor 120, may cause the electronic device 101 to control rescheduling to be performed if the current temperature of the electronic device 101 exceeds a designated range from a temperature identified before performing the application optimization.

In an embodiment, a method for optimizing an application of the electronic device 101 may include: identifying whether a state of the electronic device 101 corresponds to an application optimization execution condition; identifying whether a power level of a battery 189 being charged is lower than or equal to a designated power level; if the power level of the battery 189 being charged is lower than or equal to the designated power level, generating a list of applications for which application optimization is to be executed; identifying information on temperature of the electronic device 101; and executing application optimization based on the list and the temperature, wherein the executing of the application optimization based on the list includes adjusting the number of applications to be optimized, and the executing of the application optimization based on the temperature includes controlling to perform rescheduling if the current temperature of the electronic device is higher than a designated temperature.

In an embodiment, the method for optimizing an application of the electronic device 101 may include adjusting the number of applications to be optimized based on the list, according to a charging phase of the battery 189.

In an embodiment, the method for optimizing an application of the electronic device 101 may include generating the list by arranging, in a recent execution order, applications including a foreground activity and/or a service executed within a designated time (e.g., three days).

In an embodiment, the method for optimizing an application of the electronic device 101 may include performing rescheduling if the power level of the battery 189 being charged is higher than the designated power level.

In an embodiment, the method for optimizing an application of the electronic device 101 may include performing optimization for all applications if the power level of the battery 189 being charged is higher than the designated power level.

In an embodiment, the method for optimizing an application of the electronic device 101 may include sequentially executing application optimization based on the list and temperature, identifying whether the state of the electronic device 101 corresponds to an application optimization interrupt condition, and performing rescheduling if the state of the electronic device 101 corresponds to the interrupt condition.

In an embodiment, the method for optimizing an application of the electronic device 101 may include performing rescheduling if the electronic device 101 is out of a charging state or an idle state.

In an embodiment, the method for optimizing an application of the electronic device 101 may include, after performing the application optimization for at least one application based on the list, performing rescheduling if the current temperature of the electronic device 101 is higher than the designated temperature.

In an embodiment, the method for optimizing an application of the electronic device 101 may include performing rescheduling if the current temperature of the electronic device 101 exceeds a designated range from a temperature identified before performing the application optimization.

In an embodiment, in a non-transitory electronic device-readable recording medium storing instructions, the instructions, when executed by an electronic device, may cause the electronic device to perform: identifying whether a state of the electronic device 101 corresponds to an application optimization execution condition; identifying whether a power level of a battery 189 being charged is lower than or equal to a designated power level; if the power level of the battery 189 being charged is lower than or equal to the designated power level, generating a list of applications for which application optimization is to be executed; identifying information on temperature of the electronic device 101; and executing application optimization based on the list and the temperature, wherein the executing of the application optimization based on the list includes adjusting the number of applications to be optimized, and the executing of the application optimization based on the temperature includes controlling to perform rescheduling if the current temperature of the electronic device is higher than a designated temperature.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that the embodiments and the terms used therein are not intended to limit the technological features set forth herein to particular embodiments and the disclosure includes various changes, equivalents, and/or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a purchaser. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one processor comprising processing circuitry;
a battery; and
memory storing instructions,
wherein the instructions, when executed by the at least one processor individually or collectively, cause the electronic device to:
identify whether a state of the electronic device corresponds to an application optimization execution condition,
identify whether a power level of the battery being charged is lower than or equal to a designated power level,
in case that the power level of the battery being charged is lower than or equal to the designated power level, generate a list of applications for which application optimization is to be executed,
identify information on a temperature of the electronic device, and
execute application optimization, based on the list and the temperature,
wherein the executing of the application optimization, based on the list, comprises adjusting a number of applications to be optimized, and
wherein the executing of the application optimization, based on the temperature, comprises performing control to execute rescheduling in case that the current temperature of the electronic device exceeds a designated temperature.

2. The electronic device of claim 1, wherein the instructions, when executed by the at least one processor individually or collectively, further cause the electronic device to, according to a charging phase of the battery, adjust the number of applications to be optimized, based on the list.

3. The electronic device of claim 1, wherein the instructions, when executed by the at least one processor individually or collectively, further cause the electronic device to generate the list by arranging, in order of recent execution, applications comprising a foreground activity and/or a service executed within a designated time.

4. The electronic device of claim 1, wherein the instructions, when executed by the at least one processor individually or collectively, further cause the electronic device to:
perform control to execute rescheduling in case that the power level of the battery being charged exceeds the designated power level, and
perform control to execute optimization for all applications in case that the power level of the battery being charged exceeds the designated power level.

5. The electronic device of claim 1, wherein the application optimization execution condition is that the electronic device is in a charging state and is in an idle state.

6. The electronic device of claim 1, wherein the instructions, when executed by the at least one processor individually or collectively, further cause the electronic device to:
sequentially execute application optimization, based on the list and the temperature,
identify whether the state of the electronic device corresponds to an application optimization interrupt condition,
perform control to execute rescheduling in case that the state of the electronic device corresponds to the interrupt condition,
perform control to execute rescheduling in case that the electronic device is out of a charging state or is out of an idle state, and
after executing application optimization for at least one application, based on the list, perform control to execute rescheduling in case that the current temperature of the electronic device exceeds the designated temperature.

7. The electronic device of claim 6, wherein the instructions, when executed by the at least one processor individually or collectively, further cause the electronic device to perform control to execute rescheduling in case that the current temperature of the electronic device is out of a designated range from a temperature identified before performing the application optimization.

8. A method performed by an electronic device for optimizing an application, the method comprising:
identifying, by the electronic device, whether a state of the electronic device corresponds to an application optimization execution condition;
identifying, by the electronic device, whether a power level of a battery being charged is lower than or equal to a designated power level;
in case that the power level of the battery being charged is lower than or equal to the designated power level, generating, by the electronic device, a list of applications for which application optimization is to be executed;
identifying, by the electronic device, information on a temperature of the electronic device; and
executing, by the electronic device, application optimization, based on the list and the temperature,
wherein the executing of the application optimization, based on the list, comprises adjusting a number of applications to be optimized, and
wherein the executing of the application optimization, based on the temperature, comprises performing control to execute rescheduling in case that a current temperature of the electronic device exceeds a designated temperature.

9. The method of claim 8, further comprising, according to a charging phase of the battery, adjusting the number of applications to be optimized, based on the list.

10. The method of claim 8, further comprising generating the list by arranging, in order of recent execution, applications comprising a foreground activity and/or a service executed within a designated time.

11. The method of claim 8, further comprising:
executing rescheduling in case that the power level of the battery being charged exceeds the designated power level; and
executing optimization for all applications in case that the power level of the battery being charged exceeds the designated power level.

12. The method of claim 8, wherein the application optimization execution condition is that the electronic device is in a charging state and is in an idle state.

13. The method of claim 8, further comprising:
sequentially executing application optimization, based on the list and the temperature;
identifying whether the state of the electronic device corresponds to an application optimization interrupt condition;
executing rescheduling in case that the state of the electronic device corresponds to the interrupt condition; and
executing rescheduling in case that the electronic device is out of a charging state or is out of an idle state,
wherein the executing of the application optimization, based on the list, comprises adjusting the number of applications to be optimized, and after performing application optimization for at least one application, based on the list, executing rescheduling in case that the current temperature of the electronic device exceeds the designated temperature, and
wherein the executing of the application optimization, based on the temperature, comprises performing control to execute rescheduling in case that the current temperature of the electronic device exceeds the designated temperature.

14. The method of claim 13, further comprising executing rescheduling in case that the current temperature of the electronic device is out of a designated range from a temperature identified before performing the application optimization.

15. One or more non-transitory computer-readable recording media storing one or more computer programs including computer-executable instructions that, when executed by one or more processors of an electronic device individually or collectively, cause the electronic device to perform operations, the operations comprising:
identifying, by the electronic device, whether a state of the electronic device corresponds to an application optimization execution condition,
identifying, by the electronic device, whether a power level of a battery being charged is lower than or equal to a designated power level,
in case that the power level of the battery being charged is lower than or equal to the designated power level, generating, by the electronic device, a list of applications for which application optimization is to be executed,
identifying, by the electronic device, information on a temperature of the electronic device, and
executing, by the electronic device, application optimization, based on the list and the temperature,
wherein the executing of the application optimization, based on the list, comprises adjusting the number of applications to be optimized, and
wherein the executing of the application optimization, based on the temperature, comprises performing control to execute rescheduling in case that the current temperature of the electronic device exceeds a designated temperature.

16. The one or more non-transitory computer-readable storage media of claim 15, the operations further comprising, according to a charging phase of the battery, adjusting the number of applications to be optimized, based on the list.

17. The one or more non-transitory computer-readable storage media of claim 15, the operations further comprising generating the list by arranging, in order of recent execution, applications comprising a foreground activity and/or a service executed within a designated time.

18. The one or more non-transitory computer-readable storage media of claim 15, the operations further comprising:
executing rescheduling in case that the power level of the battery being charged exceeds the designated power level; and
executing optimization for all applications in case that the power level of the battery being charged exceeds the designated power level.

19. The one or more non-transitory computer-readable storage media of claim 15, wherein the application optimization execution condition is that the electronic device is in a charging state and is in an idle state.

20. The one or more non-transitory computer-readable storage media of claim 15, the operations further comprising:
sequentially executing application optimization, based on the list and the temperature;
identifying whether the state of the electronic device corresponds to an application optimization interrupt condition;
executing rescheduling in case that the state of the electronic device corresponds to the interrupt condition; and
executing rescheduling in case that the electronic device is out of a charging state or is out of an idle state,
wherein the executing of the application optimization, based on the list, comprises adjusting the number of applications to be optimized, and after performing application optimization for at least one application, based on the list, executing rescheduling in case that the current temperature of the electronic device exceeds the designated temperature, and
wherein the executing of the application optimization, based on the temperature, comprises performing control to execute rescheduling in case that the current temperature of the electronic device exceeds the designated temperature.
